(19) United States
(12) Patent Application Publication
(10) Pub. No.: US 2025/0171045 A1
(43) Pub. Date: May 29, 2025

(54) DISPLAY CONTROL DEVICE, METHOD, AND NON-TRANSITORY COMPUTER-READABLE MEDIUM RECORDED WITH PROGRAM

(71) Applicant: TOYOTA JIDOSHA KABUSHIKI KAISHA, Toyota-shi Aichi-ken (JP)

(72) Inventors: Hideki TSUDA, Nagoya-shi Aichi-ken (JP); Kazuhisa ISHIMARU, Nagoya-shi Aichi-ken (JP)

(73) Assignee: TOYOTA JIDOSHA KABUSHIKI KAISHA, Toyota-shi Aichi-ken (JP)

(21) Appl. No.: 18/955,371

(22) Filed: Nov. 21, 2024

(30) Foreign Application Priority Data
Nov. 29, 2023 (JP) 2023-202078

(51) Int. Cl. B60W 50/14; B60K 35/233; B60W 50/00

(52) U.S. Cl. CPC B60W 50/14; B60K 35/233; B60W 2050/0005; B60W 2050/146; B60W 2554/80

(57) ABSTRACT

A display control device including a display control section. In cases in which a change amount of a position of a target object as represented by position information output from a detection section for detecting target objects, or a physical quantity derived from this change amount, is a first specific value or lower, the display control section displays a mark in a display area of a display device at a position corresponding to a position of the target object as represented by the position information. In cases in which the change amount or the physical quantity has exceeded a second specific value that is the first specific value or greater, the display control section limits movement of a display position of the mark in the display area of the display device.

### CROSS-REFERENCE TO RELATED APPLICATION

This application claims priority under 35 USC 119 from Japanese Patent Application No. 2023-202078, filed on Nov. 29, 2023, the disclosure of which is incorporated by reference herein.

### BACKGROUND

### Technical Field

The present disclosure relates to a display control device, to a display control method, and to a non-transitory computer-readable medium recorded with a display control program.

### Related Art

WO 2017/046938 describes technology in which, when a lead vehicle of a following target in following travel control is detected, displays a mark so as to be overlaid on the lead vehicle of the following target using a head-up display (HUD).

In cases in which a mark is displayed at a position corresponding to a target object such as a lead vehicle or the like, an accuracy of positional detection of the target object by a sensor for detecting target objects varies according to, for example, a color of the target object, a distance to the target object, weather, and the like. In cases in which the accuracy of positional detection of target objects by the sensor has fallen, then this has sometimes led to a mark being displayed at a position greatly separated from the position corresponding to the target object, to oscillatory changes to the display position of the mark, and to an unsettling feeling being imparted to an occupant of an ego vehicle.

As an example, FIG. 6A illustrates a state in which a bar shaped following mark 76 is being displayed at a position corresponding to a lead vehicle 74 serving as a target object. Moreover, FIG. 6B illustrates a state in which a bar shaped following mark 76 is being displayed at a position displaced from a position corresponding to the lead vehicle 74 by 2 to 3 m in a vehicle width direction and also by a few meters in a vehicle height direction. The state illustrated in FIG. 6B sometimes imparts an unsettling feeling to an occupant. Moreover, FIG. 7 illustrates an example of timewise changes in error of positional detection of a lead vehicle in rain using a camera as an example of a sensor. Were a mark to be displayed just by using the positional detection results as illustrated in FIG. 7, then there would be oscillatory changes to the display position of the mark during period A where the error is fluctuating, and the mark would be displayed at a position greatly separated from the position corresponding to the target object in period B when tracking of the lead vehicle has been lost.

### SUMMARY

The present disclosure provides a display control device, a display control method, and a non-transitory computer-readable medium recorded with a display control program that are each capable of suppressing an unsettling feeling from being imparted to an occupant in cases in which accuracy of positional detection of target objects has fallen.

A first aspect of the present disclosure is a display control device including: a display control section configured to: display a mark in a display area of a display device at a position corresponding to a position of a target object, as represented by position information output from a detection section for detecting target objects, in cases in which a change amount of a position of the target object, as represented by the position information or a physical quantity derived from this change amount is a first specific value or lower; and to limit movement of a display position of the mark in the display area of the display device, in cases in which the change amount or the physical quantity has exceeded a second specific value that is the first specific value or greater.

In the first aspect, the position information representing the position of the target object is output from the detection section for detecting target objects. The mark is displayed at a position in the display area of the display device corresponding to the position of the target object as represented by the position information in cases in which the change amount of the position of the target object as represented by the position information or the physical quantity derived from this change amount is the first specific value or lower, namely in cases in which there is high accuracy positional detection of target objects.

On the other hand, movement of the display position of the mark in the display area of the display device is limited, in cases in which the change amount or the physical quantity has exceeded the second specific value that is the first specific value or greater, namely cases in which accuracy of positional detection of target objects has fallen. Thus, in cases in which accuracy of positional detection of target objects has fallen, the mark is able to be suppressed from being displayed at a position greatly separated from the position corresponding to the target object, oscillatory changes in the display position of the mark are able to be suppressed, and accordingly an unsettling feeling is able to be suppressed from being imparted to an occupant.

In a second aspect, in the above first aspect, the display control section may stop movement of the display position of the mark, in cases in which an average or a standard deviation of the change amount serving as the physical quantity has exceeded a first threshold serving as the second specific value.

The second aspect may enable the mark to be suppressed from being displayed at a position greatly separated from the position corresponding to the target object in cases in which accuracy of positional detection of target objects has fallen.

In a third aspect, in the above second aspect, in cases in which a distance to the target object is a specific distance or greater, the display control section may make the second specific value smaller than cases in which the distance to the target object is less than the specific distance.

From tests executed by the inventors of the present application and the like, a permissible positional displacement amount of the mark gets smaller as the distance to the target object gets larger for cases in which the mark is displayed at a position corresponding to the position of the target object. Based on this finding, in the third aspect, the second specific value is made smaller in cases in which the distance to the target object is the specific distance or greater than for cases in which the distance to the target object is less than the specific distance. This thereby may enable the displacement amount of the display position of the mark to be made smaller when the distance to the target object is comparatively large, enabling an unsettling feeling to be suppressed from being imparted to an occupant more reliably than in cases in which the distance to the target object is comparatively large.

In a fourth aspect, in the above first aspect, the display control section may make a movement amount of the display position of the mark a pre-set upper limit value or lower in cases in which the change amount has exceeded a second threshold serving as the second specific value.

In the fourth aspect, oscillatory changes to the display position of the mark may be suppressed, in cases in which the accuracy of positional detection of target objects has fallen.

In a fifth aspect, in the above first aspect, in cases in which the change amount or the physical quantity has exceeded the second specific value, the display control section may determine the display position of the mark based on the position information that was detected prior to a timing at which the change amount or the physical quantity exceeded the second specific value.

In cases in which the change amount or the physical quantity continues to exceed the second specific value, then the mark might not be able to be displayed at an appropriate position were the display position of the mark to be determined just by using the position information detected subsequently to the timing at which the change amount or the physical quantity exceeded the second specific value. Thus, in the fifth aspect the display position of the mark is determined based on the position information that was detected prior to the timing at which the change amount or the physical quantity exceeded the second specific value. This thereby may enable the mark to be displayed at an appropriate position even in cases in which the change amount or the physical quantity continues to exceed the second specific value.

In a sixth aspect, in the above first aspect, the first specific value and the second specific value may be set separately in a vehicle width direction and in a vehicle height direction; and the display control section, may set a display position of the mark for the vehicle width direction to a position corresponding to a position of the target object for the vehicle width direction, as represented by the position information, in cases in which the change amount or the physical quantity for the vehicle width direction is a first specific value or lower for the vehicle width direction, may set the display position of the mark for the vehicle width direction such that movement of the display position of the mark for the vehicle width direction in the display area of the display device is limited, in cases in which the change amount or the physical quantity for the vehicle width direction has exceeded a second specific value for the vehicle width direction, and also may set a display position of the mark for the vehicle height direction to a position corresponding to a position of the target object for the vehicle height direction, as represented by the position information, in cases in which the change amount or the physical quantity for the vehicle height direction is a first specific value or lower for the vehicle height direction, and may set the display position of the mark for the vehicle height direction such that movement of the display position of the mark for the vehicle height direction in the display area of the display device is limited, in cases in which the change amount or the physical quantity for the vehicle height direction has exceeded a second specific value for the vehicle height direction.

In cases in which the mark is displayed at a position corresponding to the position of the target object, the permissible positional displacement amounts of the mark might be different in the vehicle width direction to in the vehicle height direction. Thus, in the sixth aspect, the first specific value and the second specific value are set separately in the vehicle width direction and in the vehicle height direction, and determination as to whether or not the change amount or the physical quantity is the first specific value or lower, or has exceeded the second specific value, is determination performed for each of the vehicle width direction and the vehicle height direction. This thereby may enable the mark to be displayed at an appropriate position in both the vehicle width direction and the vehicle height direction even in cases in which the permissible positional displacement amounts of the mark are different in the vehicle width direction to in the vehicle height direction.

In a seventh aspect, in the above first aspect, the display device may be a head-up display (HUD).

The seventh aspect may enable an unsettling feeling to be suppressed from being imparted to an occupant in cases in which the accuracy of positional detection of target objects has fallen in a mode in which the mark is displayed on a display area of an HUD.

In an eighth aspect, in the above first aspect, the target object may be a lead vehicle under following control performed by adaptive cruise control (ACC).

In the eighth aspect, the mark is displayed at the position corresponding to the lead vehicle under following control performed by ACC, and so the occupant is able to be made aware of the lead vehicle under following control performed by ACC. Moreover, the present disclosure may suppress positional displacement of the mark, even in cases in which the accuracy of positional detection of target objects has fallen, and may enable an insecure feeling related to ACC accuracy or the like to be suppressed from being imparted to an occupant.

A ninth aspect of the present disclosure is a display control method that causes a computer to execute processing including displaying a mark in a display area of a display device at a position corresponding to a position of a target object, as represented by position information output from a detection section for detecting target objects, in cases in which a change amount of a position of the target object, as represented by the position information or a physical quantity derived from this change amount is a first specific value or lower; and limiting movement of a display position of the mark in the display area of the display device, in cases in which the change amount or the physical quantity has exceeded a second specific value that is the first specific value or greater.

The ninth aspect, similarly to the first aspect, may enable an unsettling feeling to be suppressed from being imparted to an occupant in cases in which accuracy of positional detection of target objects has fallen.

A tenth aspect of the present disclosure is a non-transitory computer-readable medium recorded with a display control program that causes a computer to execute processing including: displaying a mark in a display area of a display device at a position corresponding to a position of a target object, as represented by position information output from a detection section for detecting target objects, in cases in which a change amount of a position of the target object, as represented by the position information or a physical quantity derived from this change amount is a first specific value or lower; and limiting movement of a display position of the mark in the display area of the display device, in cases in which the change amount or the physical quantity has exceeded a second specific value that is the first specific value or greater.

The tenth aspect, similarly to the first aspect, may enable an unsettling feeling to be suppressed from being imparted to an occupant in cases in which accuracy of positional detection of target objects has fallen.

As described in the above aspects, a display control device, a display control method, and a non-transitory computer-readable medium recorded with a display control program of the present disclosure may enable an unsettling feeling to be suppressed from being imparted to an occupant in cases in which accuracy of positional detection of target objects has fallen.

### BRIEF DESCRIPTION OF THE DRAWINGS

Exemplary embodiments will be described in detail based on the following figures, wherein:

FIG. 1 is a block diagram illustrating a schematic configuration of an onboard system according to an exemplary embodiment;

FIG. 2 is a functional block diagram of a camera unit and a display control ECU;

FIG. 3 is an explanatory diagram illustrating a schematic configuration of an AR-HUD and the like;

FIG. 4 is a flowchart illustrating display control processing according to a first exemplary embodiment;

FIG. 5 is a graph illustrating relationships between distance to a lead vehicle, and a permissible positional displacement amount of a following mark along a vehicle height direction;

FIG. 6A is a sketch illustrating a state in which a mark is being displayed at a position corresponding to a lead vehicle;

FIG. 6B is a sketch illustrating a state in which a mark is being displayed at a position displaced from a position corresponding to a lead vehicle by 2 to 3 m in a vehicle width direction and also by a few meters in the vehicle height direction;

FIG. 7 is a graph illustrating an example of timewise changes in errors in positional detection of a lead vehicle by a camera serving as an example of a sensor;

FIG. 8 is a flowchart illustrating display control processing according to a second exemplary embodiment;

FIG. 9 is an explanatory diagram illustrating placements of an ego vehicle and a lead vehicle in tests executed by the inventors of the present application and the like;

FIG. 10A is a sketch illustrating permissible positional displacement amounts for a case in which a distance L is 100 m for a chevron-shaped mark; and

FIG. 10B is a sketch illustrating permissible positional displacement amounts for a case in which a distance L is 100 m for a flat-shaped mark.

### DETAILED DESCRIPTION

Detailed description follows regarding examples of exemplary embodiment of the present disclosure, with reference to the drawings.

### First Exemplary Embodiment

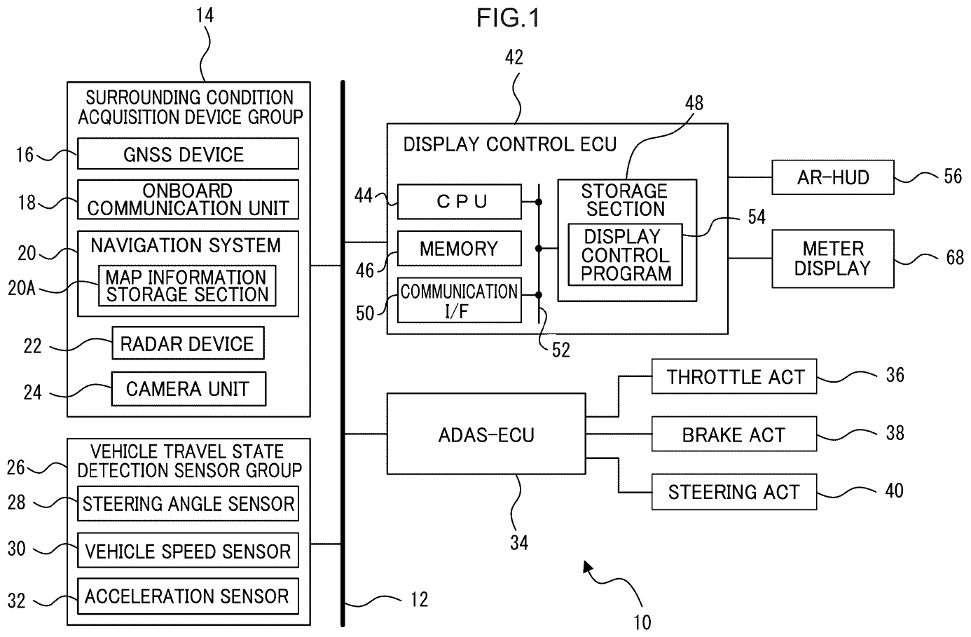

As illustrated in FIG. 1, an onboard system 10 according to the present exemplary embodiment includes a communication bus 12. A surrounding condition acquisition device group 14, a vehicle travel state detection sensor group 26, an advance driver-assistance system (ADAS)-electronic control unit (ECU) 34, and a display control ECU 42 are each connected to the communication bus 12. Note that only part of the onboard system 10 is illustrated in FIG. 1. A vehicle installed with the onboard system 10 will be referred to below as the ego vehicle.

The surrounding condition acquisition device group 14 includes, as devices to acquire information expressing conditions such what the environment around the ego vehicle is like, a global navigation satellite system (GNSS) device 16, an onboard communication unit 18, a navigation system 20, a radar device 22, a camera unit 24, and the like.

The GNSS device 16 measures the position of the ego vehicle by receiving GNSS signals from plural GNSS satellites. The onboard communication unit 18 is a communication device that performs at least one out of vehicle-to-vehicle communication with other vehicles or road-to-vehicle communication with roadside infrastructure. The navigation system 20 includes a map information storage section 20A that stores map information, and performs processing to display the position of the ego vehicle on a map and to decide a route to a destination and guide the ego vehicle there based on the position information obtained from the GNSS device 16 and the map information stored in the map information storage section 20A.

The radar device 22 detects objects such as pedestrians and other vehicles present in the surroundings of the ego vehicle as point cloud information and also acquires relative positions and relative speeds of the ego vehicle to such detected objects. The radar device 22 also removes noise and roadside objects such as guardrails from monitoring targets based on changes in the relative positions and relative speeds of the respective objects, and outputs information about the relative positions and relative speeds and the like to target objects for monitoring such as the pedestrians, other vehicles, and the like.

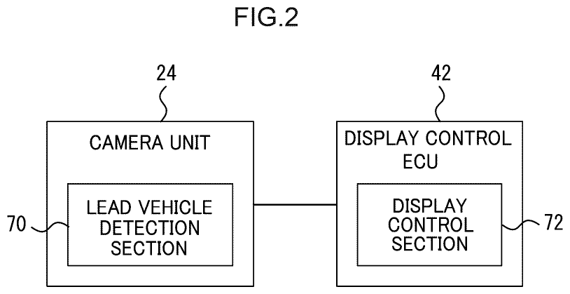

The camera unit 24 images the surroundings of the ego vehicle using plural cameras, and outputs the acquired images. Moreover, although not illustrated in the drawings, the camera unit 24 includes a central processing unit (CPU), memory such as read only memory (ROM), random access memory (RAM), and the like, and an in-built non-volatile storage section such as a hard disk drive (HDD), solid state drive (SSD), or the like. The storage section is stored with a specific program to cause the CPU of the camera unit 24 to function as a lead vehicle detection section 70 (see FIG. 2). From images of in front of the ego vehicle as captured by plural cameras, the lead vehicle detection section 70 recognizes a lead vehicle to the ego vehicle as captured in these images and, as position information, detects and outputs a distance between the ego vehicle and the lead vehicle and a relative position in a vehicle width direction. Note that an output cycle of the position information from the lead vehicle detection section 70 is, for example, 100 milliseconds.

The vehicle travel state detection sensor group 26 includes, as plural sensors for acquiring a travel state of the vehicle, a steering angle sensor 28 that detects the steering angle of the ego vehicle, a vehicle speed sensor 30 that detects the travel speed of the ego vehicle, and an acceleration sensor 32 that detects a rate of acceleration acting on the ego vehicle.

A throttle actuator (ACT) 36 that changes the throttle position of the ego vehicle, a brake actuator (ACT) 38 that changes braking force generated by a braking device of the ego vehicle, and a steering actuator (ACT) 40 that changes a steering amount of a steering device of the ego vehicle, are also each connected to the ADAS-ECU 34.

The ADAS-ECU 34 includes a CPU, memory such as ROM or RAM, a non-volatile storage section such as a hard disk drive (HDD), solid state drive (SSD), or the like, and a communication interface (I/F). ADAS software is stored in the storage section. The ADAS-ECU 34 performs autonomous driving processing to cause the ego vehicle to travel autonomously without accompanying driving operations by an occupant of the ego vehicle by the CPU executing autonomous driving software when an autonomous driving mode has been selected.

The autonomous driving processing is processing to determine a condition of the ego vehicle and its surroundings based on the information obtained from the surrounding condition acquisition device group 14 and the vehicle travel state detection sensor group 26, and is processing to control the throttle ACT 36, the brake ACT 38, and the steering ACT 40. An example of the autonomous driving processing is ACC that causes the ego vehicle to travel so as to follow a lead vehicle recognized by the camera unit 24.

The display control ECU 42 includes a CPU 44, memory 46 such as ROM or RAM, a non-volatile storage section 48 such as a hard disk drive (HDD), solid state drive (SSD), or the like, and a communication I/F 50. The CPU 44, the memory 46, the storage section 48, and the communication I/F 50 are connected together through an internal bus 52 so as to be capable of communicating with each other. A display control program 54 is stored in the storage section 48. The display control ECU 42 reads the display control program 54 from the storage section 48, expands the display control program 54 in the memory 46, and the display control ECU 42 functions as a display control section 72 as illustrated in FIG. 2, and performs display control processing, described later, by the display control program 54 expanded in the memory 46 being executed by the CPU 44.

The display control ECU 42 is connected to an augmented reality (AR)-head-up display (hereafter referred to as an AR-HUD) 56 and to a meter display 68. The AR-HUD 56 according to the present exemplary embodiment is a compact HUD that uses reflection or the like onto a windshield glass, with part of the field of view in front of a user, i.e. an occupant of the ego vehicle, as a display area (forms an image at the bottom of a scene ahead). The meter display 68 is a display provided to an instrument panel of the ego vehicle. The display control ECU 42 controls information display on the AR-HUD 56 and on the meter display 68.

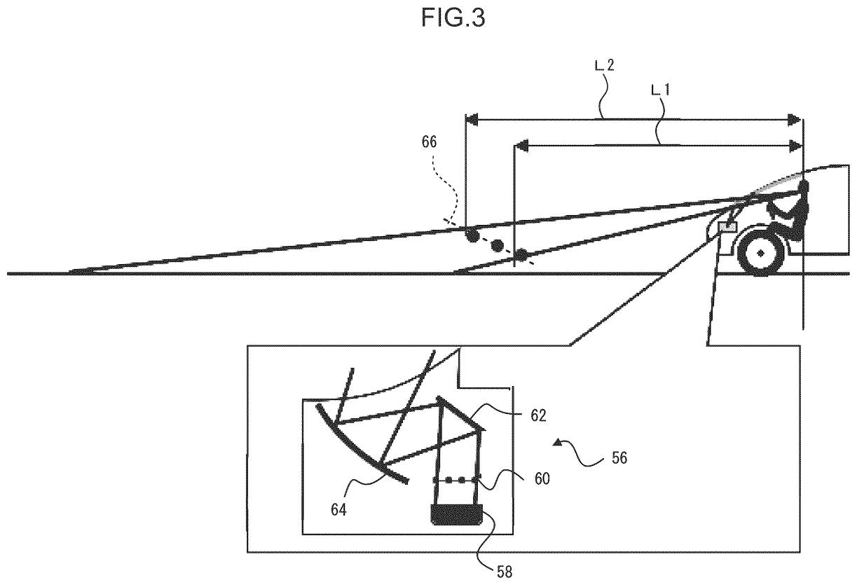

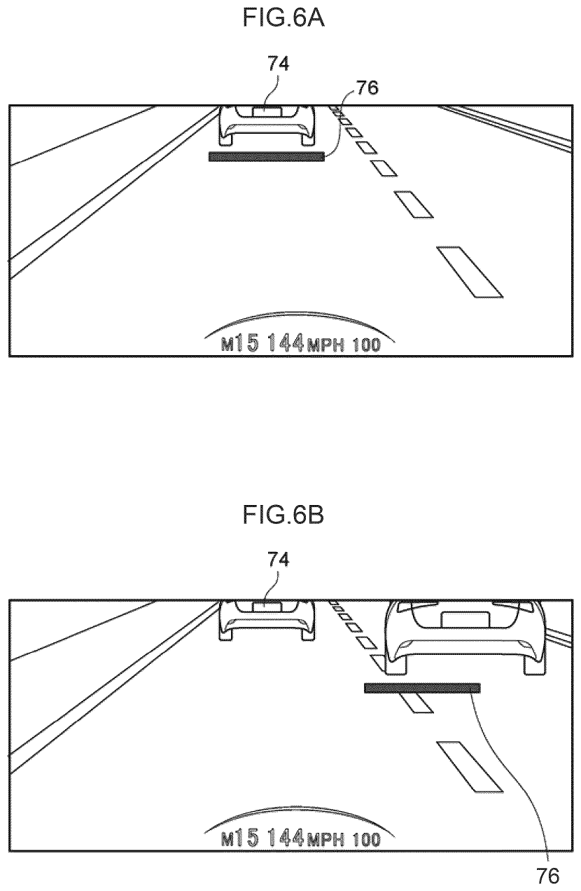

As illustrated in FIG. 3, the AR-HUD 56 includes a light source section 58 configured from light emitting diodes (LEDs) or the like, and a transmission type display section 60 configured from a liquid crystal display (LCD) or the like that has been disposed at the light emission side of the light source section 58. A convex mirror 62 and a concave mirror 64 are disposed in sequence at the light emission side of the display section 60, and light transmitted by the display section 60 is reflected in sequence by the convex mirror 62 and the concave mirror 64 and illuminated onto the windshield of the vehicle. The AR-HUD 56 has an optical system designed such that an image displayed on the display section 60 (a following mark 76 as illustrated in FIG. 6A or the like) is formed at a virtual image plane 66 inclined with respect to the vehicle height direction and floating in space at a distance of from L1 to L2 from the user. This thereby enables a user to experience an illusion as if the image formed at the virtual image plane 66 is superimposed on the road surface in front of the ego vehicle.

Note that the display control ECU 42 is an example of a display control device according to the present disclosure and of a display control section of the present disclosure. Moreover, the AR-HUD 56 is an example of a display device.

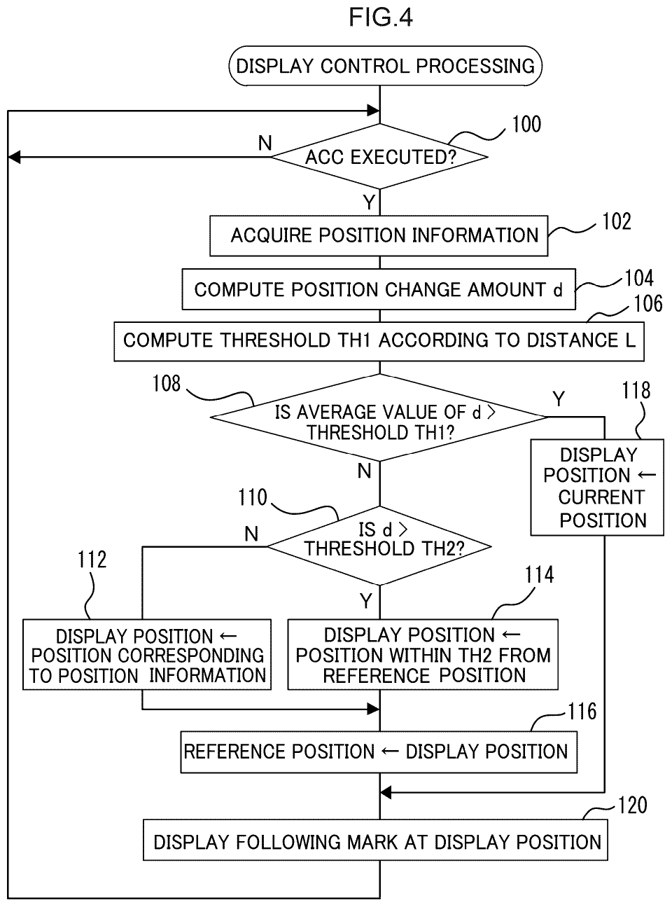

Next as an operation of the first exemplary embodiment, description follows regarding display control processing executed by the display control ECU 42 (the display control section 72) while the ignition switch of the ego vehicle is switched ON, with reference to FIG. 4.

At step 100, the display control section 72 interrogates the ADAS-ECU 34 as to whether or not ACC is being executed, and determines whether or not ACC is being executed by the ADAS-ECU 34 based on the interrogation result. When negative determination is made at step 100, the step 100 is repeated until affirmative determination is made. Processing proceeds to step 102 in cases in which affirmative determination is made at step 100.

At step 102, the display control section 72 acquires, from a lead vehicle detection section 70 of the camera unit 24, position information of a lead vehicle while following control is being performed under ACC. At step 104, the display control section 72 computes a change amount d (for example a Euclidian distance) of a position of the lead vehicle, as represented by the position information acquired at step 102, with respect to a reference position stored in the memory 46 or the like. Note that the reference position is an initial setting of a position of the lead vehicle, as represented by the position information acquired at step 102, when the display control processing is executed the first time.

Note that in the present exemplary embodiment description follows regarding a mode in which the position change amount d of the lead vehicle is computed from positional coordinates of the lead vehicle as represented by the position information. However, the display control section 72 performs processing to convert the positional coordinates of the lead vehicle into an angle of emission light from the AR-HUD 56, and to convert the angle obtained thereby into coordinates of a display position on the display section 60 of the AR-HUD 56. Thus the change amount d in the lead vehicle position and thresholds TH1, TH2, described later, may be stipulated in terms of an angle of the emission light from the AR-HUD 56, and may be stipulated in terms of coordinates of a display position on the display section 60.

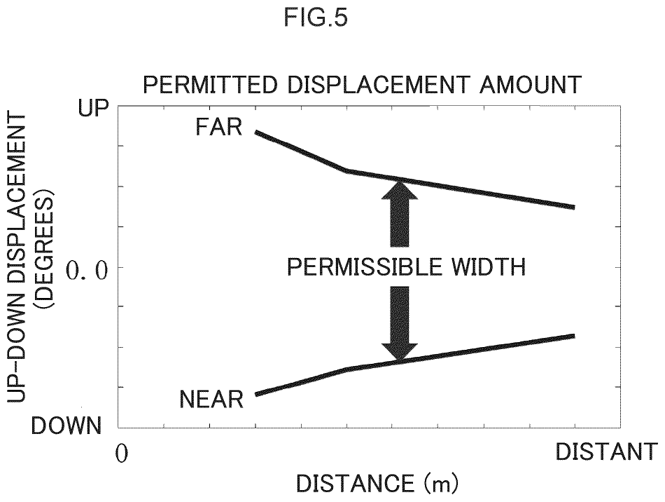

For example, as illustrated in FIG. 5, in the present exemplary embodiment a relationship is pre-set between a distance L and positional displacement amounts, such that a permitted positional displacement amount for the following mark 76 becomes smaller as a distance L to the lead vehicle becomes larger. Note that the relationship illustrated in FIG. 5 is obtained, for example, by performing the tests described later. At step 106 and based on the relationship between the distance L and the positional displacement amount, the display control section 72 computes a first threshold TH1 according to the distance L to the lead vehicle, as contained in the position information acquired from the lead vehicle detection section 70.

At step 108, the display control section 72 determines whether or not a moving average value of the position change amount d computed at step 104 exceeds the first threshold TH1 computed at step 106. Processing proceeds to step 110 in cases in which negative determination is made at step 108. At step 110, the display control section 72 determines whether or not the position change amount d computed at step 104 exceeds a second threshold TH2. The second threshold TH2 is pre-set so as to satisfy the second threshold TH2<the first threshold TH1.

Processing proceeds to step 112 in cases in which negative determination has been respectively made at steps 108, 110. At step S112, the display control section 72 sets, as a display position of the following mark 76 on the AR-HUD 56, a position corresponding to a position of the lead vehicle (for example, a position corresponding to a bottom edge of the lead vehicle) as represented by the position information acquired at step 102. Processing proceeds to step 116 after the processing of step 112 has been performed, and at step 116 the display control section 72 sets the display position of the following mark 76 to the reference position. Then at step 120 the display control section 72 displays the following mark 76 at the display position set at step 112.

In this manner, in cases in which the position change amount d of the lead vehicle as represented by the position information is the second threshold TH2 or lower (the second threshold TH2 in this case is an example of a first specific value), the following mark 76 is then displayed in the display area of the AR-HUD 56 at the position corresponding to the position of the lead vehicle as represented by the position information.

Moreover, processing proceeds to step 114 in cases in which affirmative determination is made at step 110. At step 114, the display control section 72 sets a position not greater than the second threshold TH2 from the reference position as the display position of the following mark 76 on the AR-HUD 56. Processing proceeds to step 116 after the processing of step 114 has been performed, and at step 116 the display control section 72 sets the display position of the following mark 76 as the reference position. Then at step 120, the display control section 72 displays the following mark 76 at the display position set at step 114.

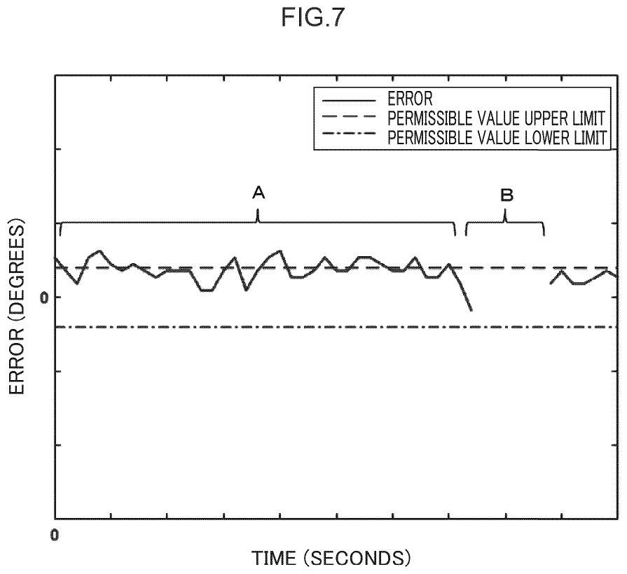

In this manner, in cases in which the position change amount d of the lead vehicle as represented by the position information satisfies the second threshold TH2<change amount d≤first threshold TH1, the movement amount of the display position of the following mark 76 on the display area of the AR-HUD 56 is limited to the second threshold TH2 or lower. This accordingly suppresses oscillatory changes to the following mark 76 on the display area of the AR-HUD 56 even, for example, in cases in which the position information input from the lead vehicle detection section 70 fluctuates as illustrated in the period A illustrated in FIG. 7. Note that the second threshold TH2 in the above processing is an example of a second specific value and of an upper limit value in the present disclosure.

On the other hand, processing proceeds to step 118 in cases in which affirmative determination has been made at step 108. At step 118, the display control section 72 sets the current position of the following mark 76 as the display position of the following mark 76 on the AR-HUD 56. Processing proceeds to step 120 after the processing of step 110 has been performed, and at step 120 the display control section 72 displays the following mark 76 at the display position set at step 118. Processing returns to step 100 after the processing of step 120 has been performed.

In this manner, the movement amount of the display position of the following mark 76 on the display area of the AR-HUD 56 is zero, in cases in which the position change amount d of the lead vehicle as represented by the position information satisfies the change amount d>the first threshold TH1. This accordingly suppresses the following mark 76 from being displayed at a position greatly separated from the position corresponding to the lead vehicle on the display area of the AR-HUD 56, even in cases in which the position information input from the lead vehicle detection section 70 indicates values when tracking of the lead vehicle has been lost, for example as illustrated in the period B illustrated in FIG. 7. Note that the first threshold TH1 in the above processing is an example of the second specific value.

Moreover, the reference position is not updated in cases in which the change amount d>the first threshold TH1 and so, in a continuing state of the change amount d>the first threshold TH1, the display position of the following mark 76 is determined based on the position information detected prior to the timing at which change amount d>first threshold TH1 was satisfied. This thereby enables the following mark 76 to be displayed at an appropriate position even in a continuing state of the change amount d>first threshold TH1.

As described above, in the first exemplary embodiment, the position information expressing the position of the lead vehicle is input to the display control section 72 (the display control ECU 42) from the lead vehicle detection section 70. In cases in which a change amount in the lead vehicle position, or in a physical quantity derived from this change amount, is the first specific value or lower, the following mark 76 is displayed in the display area of the AR-HUD 56 at a position corresponding to the position of the lead vehicle as represented by the position information. On the other hand, in cases in which the change amount in the lead vehicle position, or in the physical quantity derived from this change amount, exceeds the second specific value that is the first specific value or greater, a shift in the display position of the following mark 76 in the display area of the AR-HUD 56 is limited. Thus, in cases in which there is a drop in the accuracy of positional detection of the lead vehicle, the following mark 76 is suppressed from being displayed at a position greatly separated from the position corresponding to the lead vehicle, the display position of the following mark 76 is suppressed from oscillatory changes, and an unsettling feeling is suppressed from being imparted to an occupant.

Moreover, in the first exemplary embodiment, the display control section 72 stops a shift in the display position of the following mark 76 in cases in which an average or a standard deviation of the change amount in the lead vehicle position, serving as the physical quantity derived from the change amount, has exceeded the first threshold TH1 serving as the second specific value. This thereby enables the following mark 76 to be suppressed from being displayed at a position greatly separated from the position corresponding to the lead vehicle, in cases in which accuracy of positional detection of the lead vehicle has fallen.

In the first exemplary embodiment, in cases in which the distance L to the lead vehicle is a specific distance or greater, the display control section 72 makes the first threshold TH1 smaller than when the distance L to the lead vehicle is less than the specific distance. This thereby enables the positional displacement amount of the following mark 76 to be made smaller, in cases in which the distance L to the lead vehicle is comparatively large, and enables an unsettling feeling to be suppressed from being imparted to an occupant more reliably than in cases in which the distance L to the lead vehicle is comparatively large.

Moreover, in the first exemplary embodiment, in cases in which the movement amount in the lead vehicle position has exceeded the second threshold TH2 serving as the second specific value, the display control section 72 sets a change amount of the display position of the following mark 76 to a pre-set upper limit value or lower. This thereby enables the display position of the following mark 76 to be suppressed from oscillatory changes, in cases in which accuracy of positional detection of the lead vehicle has fallen.

Moreover, in the first exemplary embodiment, in cases in which the change amount in the lead vehicle position, or in a physical quantity derived from this change amount, has exceeded the second specific value, the display control section 72 determines the display position of the following mark 76 based on the position information detected prior to the timing when the change amount or the physical quantity exceeded the second specific value. This thereby enables the following mark 76 to be displayed at an appropriate position in cases in which the change amount or the physical quantity has continued exceeding the second specific value.

Moreover, in the first exemplary embodiment, the AR-HUD 56 is applied as a display device of the present disclosure. This thereby enables an unsettling feeling to be suppressed from being imparted to an occupant in cases in which accuracy of positional detection of the lead vehicle has fallen in the present mode of displaying the following mark 76 in the display area of the AR-HUD 56.

Moreover, in the first exemplary embodiment, the lead vehicle is a lead vehicle under following control being performed by ACC. This thereby enables the occupant to be made aware of the lead vehicle when following control is being performed by ACC, and also enables an insecure feeling related to ACC accuracy or the like to be suppressed from being imparted to an occupant.

### Second Exemplary Embodiment

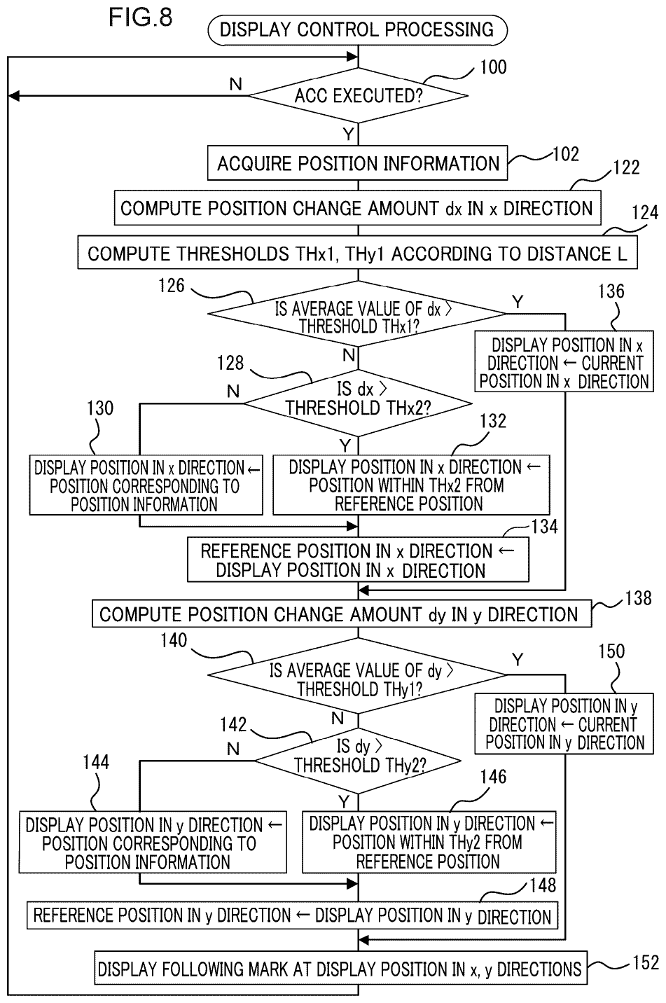

Next, description follows regarding a second exemplary embodiment of the present disclosure. Note that the second exemplary embodiment has the same configuration as the first exemplary embodiment, and so the display control processing according to the second exemplary embodiment will now be described with reference to FIG. 8, with the same reference numerals appended in the drawings to the same parts, with description of such configuration omitted. Note that in the second exemplary embodiment a vehicle width direction is called an x direction, and a vehicle height direction is called a y direction.

In the display control program according to the second exemplary embodiment, processing proceeds to step 122 when position information of a lead vehicle has been acquired at step 102. At step S122, the display control section 72 computes a change amount dx for the x direction of a lead vehicle position, as represented by the position information acquired at step 102, with respect to the reference position. At step 124, based on a relationship between a distance L and a positional displacement amount (see FIG. 5), the display control section 72 computes each of a first threshold THx1 for the x direction and a first threshold THy1 for the y direction as first thresholds according to the distance L to the lead vehicle.

At step 126, the display control section 72 determines whether or not the moving average value of the position change amount dx for the x direction computed at step 122 exceeds the first threshold THx1 for the x direction computed at step 124. Processing proceeds to step 128 when negative determination is made at step 126. At step 128, the display control section 72 determines whether or not the position change amount dx for the x direction computed at step 122 exceeds a second threshold THx2 for the x direction. The second threshold THx2 is pre-set such that the second threshold THx2 for the x direction<the first threshold THx1 for the x direction.

Processing proceeds to step 130 when negative determination has been respectively made at steps 126, 128. At step 130, the display control section 72 sets a position in the x direction corresponding to the lead vehicle position, as represented by the position information acquired at step 102 as an x direction display position of the following mark 76 on the AR-HUD 56. Processing proceeds to step 134 when the processing of step 130 has been performed, and at step 134 the display control section 72 sets the x direction display position of the following mark 76 to the x direction reference position.

Moreover, processing proceeds to step 132 in cases in which affirmative determination is made at step 128. At step 132, the display control section 72 sets a position that is within the x direction second threshold THx2 from the x direction reference position as the x direction display position of the following mark 76 on the AR-HUD 56. Processing proceeds to step 134 when the processing of step 132 has been performed, and at step 134 the display control section 72 sets the x direction display position of the following mark 76 to the x direction reference position.

On the other hand, processing proceeds to step 136 when affirmative determination has been made at step 126. At step 136, the display control section 72 sets the x direction current position of the following mark 76 as the x direction display position of the following mark 76 on the AR-HUD 56. Processing proceeds to step 138 when the processing of step 136 has been performed.

At step 138, the display control section 72 computes a change amount dy for the y direction of the lead vehicle position as represented by the position information acquired at step 102 with respect to the reference position. At step 140, the display control section 72 determines whether or not a moving average value of the position change amount dy for the y direction computed at step 138 exceeds a first threshold THy1 for the y direction as computed at step 124.

Processing proceeds to step 142 when negative determination is made at step 140. At step 142, the display control section 72 determines whether or not the position change amount dy for the y direction computed at step 138 exceeds the y direction second threshold THy2. Note that, the second threshold THy2 is pre-set such that the y direction second threshold THy2<the y direction first threshold THy1.

Processing proceeds to step 144 when negative determination has been respectively made at steps 140, 142. Then at step 144, the display control section 72 sets a y direction position corresponding to the lead vehicle position as represented by the position information acquired at step 102 as the y direction display position of the following mark 76 on the AR-HUD 56. Processing proceeds to step 148 when the processing of step 144 has been performed, and at step 148 the display control section 72 sets the y direction display position of the following mark 76 to the y direction reference position.

Moreover, processing proceeds to step 146 when affirmative determination has been made at step 142. At step 146, the display control section 72 sets a position within the y direction second threshold THy2 from the y direction reference position as the y direction display position of the following mark 76 on the AR-HUD 56. Processing proceeds to step 148 when the processing of step 146 has been performed and at step 148 the display control section 72 sets the y direction display position of the following mark 76 to the y direction reference position.

On the other hand, processing proceeds to step 150 when affirmative determination is made at step 140. At step 150, the display control section 72 sets the y direction current position of the following mark 76 as the y direction display position of the following mark 76 on the AR-HUD 56. Processing proceeds to step 152 when the processing of step 150 has been performed.

At step 152, the display control section 72 displays the following mark 76 at a position corresponding to the x direction display position set at step 130 or 134 or 136, and to the y direction display position set at step 144 or 146 or 150. Processing returns to step 100 when the processing of step 152 has been performed.

In cases in which the following mark 76 is displayed at the position corresponding to the lead vehicle, a difference might possibly emerge between permissible positional displacement amounts for the following mark 76 in the x direction and the y direction. Thus in the second exemplary embodiment, the first specific value (second threshold) and the second specific value (first threshold) are separately set for the x direction and the y direction, and determination as to whether or not the position change amounts dx, dy or the moving average value thereof is the first specific value or lower or has exceeded the second specific value is performed separately for the x direction and the y direction. This thereby enables the following mark 76 to be displayed at appropriate respective positions in the x direction and the y direction even when permissible positional displacement amounts of the following mark 76 are different in the x direction and the y direction.

Note that in the exemplary embodiment described above an example has been described that combines a mode to stop movement of the following mark 76 when the moving average of the position change amount d has exceeded the first threshold (as an example of the second specific value), and a mode to limit the movement amount of the mark in cases in which the position change amount d has exceeded the second threshold (as an example of the first specific value). However, each of the above two modes may be executed individually, and in such cases, for example, a setting may be employed in which the first specific value=the second specific value.

Moreover, in the exemplary embodiment described above, a mode has been described in which the moving average is employed as an example of a physical quantity derived from a position change amount of a target object, however the present disclosure is not limited thereto, and a standard deviation or the like may be employed instead of the moving average.

Moreover, although in the exemplary embodiment described above a mode applied to a lead vehicle under following control performed by ACC has been described as an example of the target object of the present disclosure, the target object of the present disclosure is not limited to being a lead vehicle and, for example, may be a pedestrian or the like.

Furthermore, although in the exemplary embodiment described above, a mode has been described in which the following mark 76 or the like is displayed at a position corresponding to the target object contained in a scene in front of a vehicle being viewed through a display area of the AR-HUD 56, the present disclosure is not limited thereto. For example, the AR-HUD 56 may be configured so as to display an image simulating a scene in front of the ego vehicle in a display area of the AR-HUD 56, and so as to display the following mark 76 or the like at a position corresponding to a target object contained in the image simulating a scene in front of the ego vehicle.

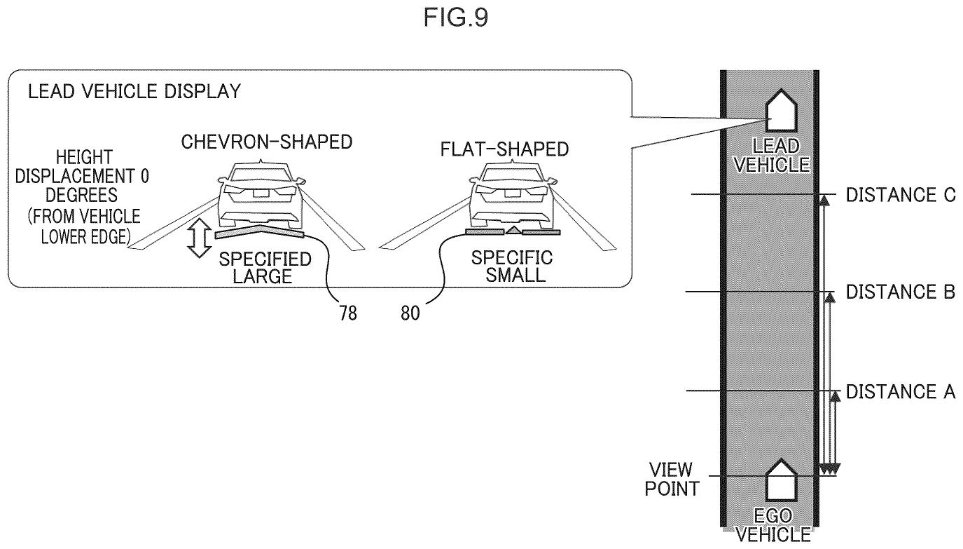

Moreover, the mark of the present disclosure is not limited to the bar shaped following mark 76 illustrated in FIG. 6A and FIG. 6B and, for example, application may be made to a chevron-shaped mark 78 or a flat-shaped mark 80 as illustrated in FIG. 9, or to a mark of another shape.

Moreover, in the exemplary embodiment described above, a mode with the AR-HUD 56 applied as an example of a display device of the present disclosure has been described, however the present disclosure is not limited thereto, and the display device of the present disclosure may be a meter display 68.

Furthermore, a mode has been described above in which the display control program 54 that is an example of a display control program according to the present disclosure is pre-stored (installed) on the storage section 48. However, the display control program according to the present disclosure may be provided in a format recorded on a non-transitory recording medium such as an HDD, SSD, DVD or the like.

In relation to the exemplary embodiment described above, the following supplements are also disclosed.

### Supplement 1

A display control device including: a display control section configured to:
display a mark in a display area of a display device at a position corresponding to a position of a target object as represented by position information output from a detection section for detecting target objects, in cases in which a change amount of a position of the target object as represented by the position information or a physical quantity derived from this change amount is a first specific value or lower, and
to limit movement of a display position of the mark in the display area of the display device, in cases in which the change amount or the physical quantity has exceeded a second specific value that is the first specific value or greater.

### Supplement 2

The display control device of Supplement 1, wherein the display control section stops movement of the display position of the mark in cases in which an average or a standard deviation of the change amount serving as the physical quantity has exceeded a first threshold serving as the second specific value.

### Supplement 3

The display control device of Supplement 2, wherein in cases in which a distance to the target object is a specific distance or greater, the display control section makes the second specific value smaller than cases in which the distance to the target object is less than the specific distance.

### Supplement 4

The display control device of any one of Supplement 1 to Supplement 3, wherein the display control section makes a movement amount of the display position of the mark a pre-set upper limit value or lower, in cases in which the change amount has exceeded a second threshold serving as the second specific value.

### Supplement 5

The display control device of any one of Supplement 1 to Supplement 4, wherein, in cases in which the change amount or the physical quantity has exceeded the second specific value, the display control section determines the display position of the mark based on the position information that was detected prior to a timing at which the change amount or the physical quantity exceeded the second specific value.

### Supplement 6

The display control device of any one of Supplement 1 to Supplement 5, wherein:
the first specific value and the second specific value are set separately in a vehicle width direction and in a vehicle height direction; and
the display control section,
sets a display position of the mark for the vehicle width direction to a position corresponding to a position of the target object for the vehicle width direction as represented by the position information, in cases in which the change amount or the physical quantity for the vehicle width direction is a first specific value or lower for the vehicle width direction,
sets the display position of the mark for the vehicle width direction such that movement of the display position of the mark for the vehicle width direction in the display area of the display device is limited, in cases in which the change amount or the physical quantity for the vehicle width direction has exceeded a second specific value for the vehicle width direction, and also
sets a display position of the mark for the vehicle height direction to a position corresponding to a position of the target object for the vehicle height direction as represented by the position information, in cases in which the change amount or the physical quantity for the vehicle height direction is a first specific value or lower for the vehicle height direction, and
sets the display position of the mark for the vehicle height direction such that movement of the display position of the mark for the vehicle height direction in the display area of the display device is limited, in cases in which the change amount or the physical quantity for the vehicle height direction has exceeded a second specific value for the vehicle height direction.

### Supplement 7

The display control device of any one of Supplement 1 to Supplement 6, wherein the display device is a head-up display.

### Supplement 8

The display control device of any one of Supplement 1 to Supplement 7, wherein the target object is a lead vehicle under following control performed by adaptive cruise control.

### Supplement 9

A display control method of processing executed by a computer, the processing including:
displaying a mark in a display area of a display device at a position corresponding to a position of a target object as represented by position information output from a detection section for detecting target objects, in cases in which a change amount of a position of the target object as represented by the position information or a physical quantity derived from this change amount is a first specific value or lower, and
limiting movement of a display position of the mark in the display area of the display device, in cases in which the change amount or the physical quantity has exceeded a second specific value that is the first specific value or greater.

### Supplement 10

The display control method of Supplement 9, wherein movement of the display position of the mark is stopped, in cases in which an average or a standard deviation of the change amount serving as the physical quantity has exceeded a first threshold serving as the second specific value.

### Supplement 11

The display control method of Supplement 10, wherein, in cases in which a distance to the target object is a specific distance or greater, the second specific value is made smaller than cases in which the distance to the target object is less than the specific distance.

### Supplement 12

The display control method of any one of Supplement 9 to Supplement 11, wherein a movement amount of the display position of the mark is made a pre-set upper limit value or lower, in cases in which the change amount has exceeded a second threshold serving as the second specific value.

### Supplement 13

The display control method of any one of Supplement 9 to Supplement 12, wherein, in cases in which the change amount or the physical quantity has exceeded the second specific value, the display position of the mark is determined based on the position information that was detected prior to a timing at which the change amount or the physical quantity exceeded the second specific value.

### Supplement 14

The display control method of any one of Supplement 9 to Supplement 13, wherein: the first specific value and the second specific value are set separately in a vehicle width direction and in a vehicle height direction; and
a display position of the mark for the vehicle width direction is set to a position corresponding to a position of the target object for the vehicle width direction as represented by the position information, in cases in which the change amount or the physical quantity for the vehicle width direction is a first specific value or lower for the vehicle width direction,
the display position of the mark for the vehicle width direction is set such that movement of the display position of the mark for the vehicle width direction in the display area of the display device is limited, in cases in which the change amount or the physical quantity for the vehicle width direction has exceeded a second specific value for the vehicle width direction, and also
a display position of the mark for the vehicle height direction is set to a position corresponding to a position of the target object for the vehicle height direction as represented by the position information, in cases in which the change amount or the physical quantity for the vehicle height direction is a first specific value or lower for the vehicle height direction, and
the display position of the mark for the vehicle height direction is set such that movement of the display position of the mark for the vehicle height direction in the display area of the display device is limited, in cases in which the change amount or the physical quantity for the vehicle height direction has exceeded a second specific value for the vehicle height direction.

### Supplement 15

The display control method of any one of Supplement 9 to Supplement 14, wherein the display device is a head-up display.

### Supplement 16

The display control method of any one of Supplement 9 to Supplement 15, wherein the target object is a lead vehicle under following control performed by adaptive cruise control.

### Supplement 17

A display control program to cause a computer to execute processing including:
displaying a mark in a display area of a display device at a position corresponding to a position of a target object as represented by position information output from a detection section for detecting target objects, in cases in which a change amount of a position of the target object as represented by the position information or a physical quantity derived from this change amount is a first specific value or lower, and
limiting movement of a display position of the mark in the display area of the display device, in cases in which the change amount or the physical quantity has exceeded a second specific value that is the first specific value or greater.

### Supplement 18

The display control program of Supplement 17, wherein movement of the display position of the mark is stopped, in cases in which an average or a standard deviation of the change amount serving as the physical quantity has exceeded a first threshold serving as the second specific value.

### Supplement 19

The display control program of Supplement 18, wherein, in cases in which a distance to the target object is a specific distance or greater, the second specific value is made smaller than cases in which the distance to the target object is less than the specific distance.

### Supplement 20

The display control program of any one of Supplement 17 to Supplement 19, wherein a movement amount of the display position of the mark is made a pre-set upper limit value or lower, in cases in which the change amount has exceeded a second threshold serving as the second specific value.

### Supplement 21

The display control program of any one of Supplement 17 to Supplement 20, wherein, in cases in which the change amount or the physical quantity has exceeded the second specific value, the display position of the mark is determined based on the position information that was detected prior to a timing at which the change amount or the physical quantity exceeded the second specific value.

### Supplement 22

The display control program of any one of Supplement 17 to Supplement 21, wherein:
the first specific value and the second specific value are set separately in a vehicle width direction and in a vehicle height direction; and
a display position of the mark for the vehicle width direction is set to a position corresponding to a position of the target object for the vehicle width direction as represented by the position information, in cases in which the change amount or the physical quantity for the vehicle width direction is a first specific value or lower for the vehicle width direction,
the display position of the mark for the vehicle width direction is set such that movement of the display position of the mark for the vehicle width direction in the display area of the display device is limited, in cases in which the change amount or the physical quantity for the vehicle width direction has exceeded a second specific value for the vehicle width direction, and also
a display position of the mark for the vehicle height direction is set to a position corresponding to a position of the target object for the vehicle height direction as represented by the position information, in cases in which the change amount or the physical quantity for the vehicle height direction is a first specific value or lower for the vehicle height direction, and
the display position of the mark for the vehicle height direction is set such that movement of the display position of the mark for the vehicle height direction in the display area of the display device is limited, in cases in which the change amount or the physical quantity for the vehicle height direction has exceeded a second specific value for the vehicle height direction.

### Supplement 23

The display control program of any one of Supplement 17 to Supplement 22, wherein the display device is a head-up display.

### Supplement 24

The display control program of any one of Supplement 17 to Supplement 23, wherein the target object is a lead vehicle under following control performed by adaptive cruise control.

Description follows regarding tests executed by the inventors of the present application. In these tests, as illustrated in FIG. 9, an ego vehicle in which a tester was riding was placed on a test road, and a lead vehicle was placed on the test road in front of the ego vehicle. Moreover, a following mark was displayed by a AR-HUD 56 of the ego vehicle so as to be superimposed on a scene in front of the ego vehicle at a position approximately corresponding to the lead vehicle. Note that, each of a chevron-shaped mark 78 and a flat-shaped mark 80 as illustrated in FIG. 9 were employed as the superimposed-displayed following mark. The display position of the following mark was then changed in the vehicle height direction, and an evaluation by the tester as to whether or not the following mark was perceived to be positionally displaced at each display position was performed while the position of the lead vehicle was moved in a range of from 30 m to 100 m in front of the ego vehicle, with this evaluation performed by plural testers.

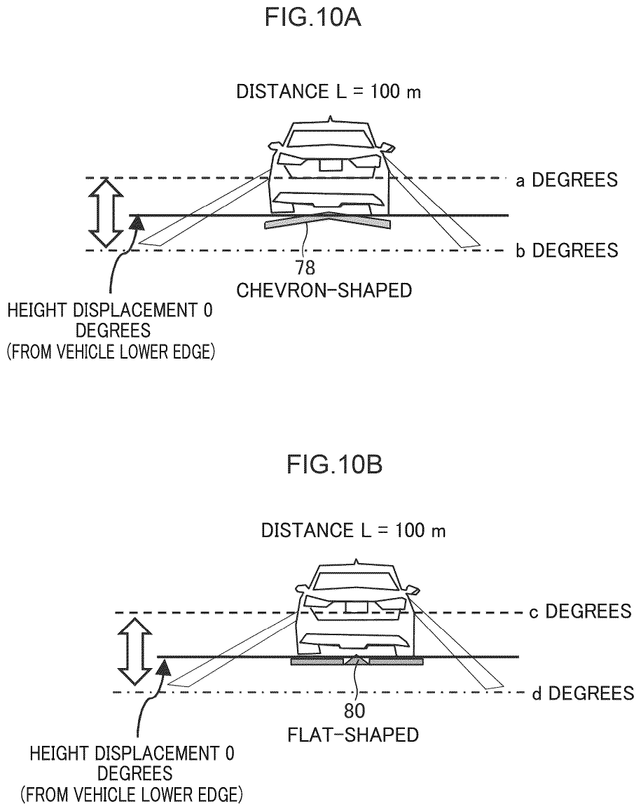

As a result of these tests, permissible positional displacement amounts are indicated in FIG. 10A for a distance L=100 m between the ego vehicle and the lead vehicle for cases in which the chevron-shaped mark 78 was employed as the following mark. Moreover, permissible positional displacement amounts are indicated in FIG. 10B for a distance L=100 m between the ego vehicle and the lead vehicle for cases in which the flat-shaped mark 80 was employed as the following mark. As illustrated in FIG. 10A and FIG. 10B, it is apparent from these test that the flat-shaped mark 80 had a larger permissible positional displacement amount than the chevron-shaped mark 78 for the upward direction in the vehicle height direction, and that the chevron-shaped mark 78 had a larger permissible positional displacement amount than the flat-shaped mark 80 for the downward direction thereof.

Moreover, relationships of the distance L between the ego vehicle and the lead vehicle to the permissible positional displacement amounts of the following mark for when the chevron-shaped mark 78 was employed are illustrated in FIG. 5. As a result, it is apparent that the positional displacement amount of the mark that is permissible for cases in which the mark is displayed at a position corresponding to the position of a target object such as a lead vehicle or the like gets smaller as the distance to the target object gets larger.

What is claimed is:

1. A display control device comprising:
a memory; and
a processor coupled to the memory, the processor being configured to:
display a mark in a display area of a display device at a position corresponding to a position of a target object, as represented by position information output from a detection section for detecting target objects, in cases in which a change amount of a position of the target object, as represented by the position information or a physical quantity derived from this change amount is a first specific value or lower; and
limit movement of a display position of the mark in the display area of the display device, in cases in which the change amount or the physical quantity has exceeded a second specific value that is the first specific value or greater.

2. The display control device of claim 1, wherein the processor is configured to stop movement of the display position of the mark, in cases in which an average or a standard deviation of the change amount serving as the physical quantity has exceeded a first threshold serving as the second specific value.

3. The display control device of claim 2, wherein, in cases in which a distance to the target object is a specific distance or greater, the processor is configured to make the second specific value smaller than cases in which the distance to the target object is less than the specific distance.

4. The display control device of claim 1, wherein the processor is configured to make a movement amount of the display position of the mark a pre-set upper limit value or lower, in cases in which the change amount has exceeded a second threshold serving as the second specific value.

5. The display control device of claim 1, wherein, in cases in which the change amount or the physical quantity has exceeded the second specific value, the processor is configured to determine the display position of the mark based on the position information that was detected prior to a timing at which the change amount or the physical quantity exceeded the second specific value.

6. The display control device of claim 1, wherein:
the first specific value and the second specific value are set separately in a vehicle width direction and in a vehicle height direction; and
the processor is configured to:
set a display position of the mark for the vehicle width direction to a position corresponding to a position of the target object for the vehicle width direction, as represented by the position information, in cases in which the change amount or the physical quantity for the vehicle width direction is a first specific value or lower for the vehicle width direction,
set the display position of the mark for the vehicle width direction such that movement of the display position of the mark for the vehicle width direction in the display area of the display device is limited, in cases in which the change amount or the physical quantity for the vehicle width direction has exceeded a second specific value for the vehicle width direction, and also
set a display position of the mark for the vehicle height direction to a position corresponding to a position of the target object for the vehicle height direction, as represented by the position information, in cases in which the change amount or the physical quantity for the vehicle height direction is a first specific value or lower for the vehicle height direction, and
set the display position of the mark for the vehicle height direction such that movement of the display position of the mark for the vehicle height direction in the display area of the display device is limited, in cases in which the change amount or the physical quantity for the vehicle height direction has exceeded a second specific value for the vehicle height direction.

7. The display control device of claim 1, wherein the display device is a head-up display.

8. The display control device of claim 1, wherein the target object is a lead vehicle under following control performed by adaptive cruise control.

9. A display control method of processing executed by a computer, the processing comprising:
displaying a mark in a display area of a display device at a position corresponding to a position of a target object, as represented by position information output from a detection section for detecting target objects, in cases in which a change amount of a position of the target object, as represented by the position information or a physical quantity derived from this change amount is a first specific value or lower; and
limiting movement of a display position of the mark in the display area of the display device, in cases in which the change amount or the physical quantity has exceeded a second specific value that is the first specific value or greater.

10. A non-transitory computer-readable medium recorded with a display control program that causes a computer to execute processing comprising:
displaying a mark in a display area of a display device at a position corresponding to a position of a target object, as represented by position information output from a detection section for detecting target objects, in cases in which a change amount of a position of the target object, as represented by the position information or a physical quantity derived from this change amount is a first specific value or lower; and
limiting movement of a display position of the mark in the display area of the display device, in cases in which the change amount or the physical quantity has exceeded a second specific value that is the first specific value or greater.
